(19) United States
(12) Patent Application Publication
(10) Pub. No.: US 2022/0355623 A1
(43) Pub. Date: Nov. 10, 2022

(54) VEHICLE TIRES WITH RETRACTABLE GRIPPING MEMBERS

(71) Applicant: Kevin Edward Thomsen, Armstrong (CA)

(72) Inventor: Kevin Edward Thomsen, Armstrong (CA)

(21) Appl. No.: 17/307,278

(22) Filed: May 4, 2021

(51) Int. Cl. B60C 11/16

(52) U.S. Cl. CPC B60C 11/1612

(57) ABSTRACT

A vehicle tire that is configured to assist a driver traverse hazardous conditions such as but not limited to snow or ice. The vehicle tire of the present invention includes a tread assembly having a base member. Integrally formed into the base member are a plurality of chambers. The chambers have an interior volume wherein each chamber includes a gripping member sealably and movably mounted therein. The gripping member is movable in an outwards-inwards direction wherein the movement is controller by air pressure and a spring. The gripping members are deployed to their second position so as to extend beyond the upper surface of the base member in order to provide improved traction for the vehicle on which the vehicle tire of the present invention is installed. The chambers are pneumatically coupled with each other and the tire with a tubing network.

### FIELD OF THE INVENTION

The present invention relates generally to vehicle tires, more specifically but not by way of limitation, a vehicle tire that is configured to assist a vehicle traverse inclement conditions such as snow and ice wherein the vehicle tire of the present invention includes a plurality of retractable gripping members.

### BACKGROUND

As is known in the art, seasonal changes introduce hazardous driving conditions. In tropical climates, torrential rains can create dangerous driving conditions and in northern areas it is the winter season and the impact of the weather that presents numerous challenges for drivers. In geographical areas that experience snow and ice there are many manners in which to attempt to reduce the hazards presented by the road conditions. Many municipalities and other government entities will disperse salt and/or sand on the roads after a snow or ice storm in order to attempt to improve the roadways conditions for drivers. While this technique can work, there are many areas that do not have this type of service. Another technique drivers employ is to install snow tires on their vehicle. In many parts of the world, snow tires are required to be installed by a certain date prior to the commencement of the winter season. While snow tires are effective for light duty vehicles they do not effectively work on commercial vehicles.

During the winter season when hazardous road conditions are present it is quite common for commercial vehicles such as but not limited to tractor trailers to install chains on their tires. Chains provide a substantially improved grip and can be installed and removed as needed upon encountering of road conditions that require the chains. While chains have proven effective the installation and removal thereof is significantly inconvenient. Often chains must be installed during inclement weather and results in a challenge for the driver to install them during snowy or icy conditions.

It is intended within the scope of the present invention to provide a vehicle tire that includes retractable gripping members wherein the gripping members are integrally mounted within the tread assembly of the tire and are pneumatically coupled to the air pressure system of the tire so as to facilitate deployment of the gripping members from the passenger cabin of the vehicle.

### SUMMARY OF THE INVENTION

It is the object of the present invention to provide a vehicle tire that is configured to improve traction on roadways during inclement weather wherein the vehicle tire of the present invention includes a tread assembly.

Another object of the present invention is to provide a vehicle tire that is operable to deploy gripping members so as to improve traction on surfaces such as but not limited to snow and ice wherein the tread assembly of the present invention includes a plurality of pneumatically operated gripping members.

A further object of the present invention is to provide a vehicle tire that is configured to improve traction on roadways during inclement weather wherein the gripping members are movably mounted within the tread assembly.

Still another object of the present invention is to provide a vehicle tire that is operable to deploy gripping members so as to improve traction on surfaces such as but not limited to snow and ice wherein the gripping members are pneumatically coupled to the air pressure of the tire.

An additional object of the present invention is to provide a vehicle tire that is configured to improve traction on roadways during inclement weather wherein the gripping members are secured to a pressure sensitive mounting spring that is operable to move the gripping members from a first position to a second position.

Yet a further object of the present invention is to provide a vehicle tire that is operable to deploy gripping members so as to improve traction on surfaces such as but not limited to snow and ice wherein the gripping members are sealable secured within the tread assembly.

Another object of the present invention is to a provide a vehicle tire that is configured to improve traction on roadways during inclement weather wherein the gripping members are generally cylindrical in shape.

An alternate object of the present invention is to provide a vehicle tire that is operable to deploy gripping members so as to improve traction on surfaces such as but not limited to snow and ice wherein the plurality of gripping members are pneumatically coupled with an air tubing network.

Still a further object of the present invention is to provide a vehicle tire that is configured to improve traction on roadways during inclement weather wherein the gripping members are manufactured from metal.

An additional object of the present invention is to provide a vehicle tire that is operable to deploy gripping members so as to improve traction on surfaces such as but not limited to snow and ice wherein the vehicle tire in a preferred embodiment is pneumatically controlled by a central tire inflation system.

An additional object of the present invention is to provide a vehicle tire that is configured to improve traction on roadways during inclement weather wherein the vehicle tire of the present invention is provided in alternate sizes.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic cross section of the tread assembly of the present invention detailing one gripping member; and

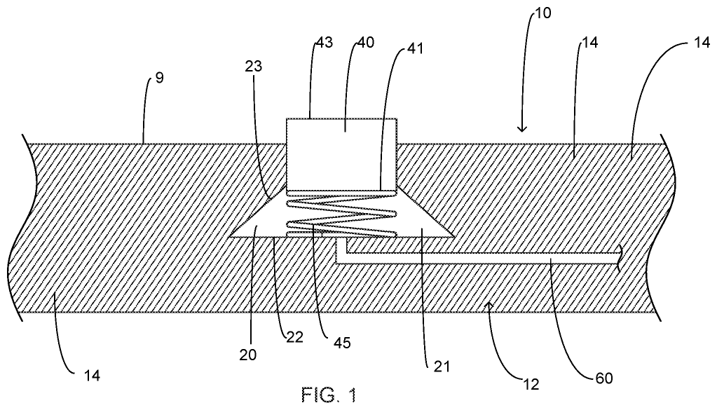

FIG. 2 is a cross-section perspective view of the present invention.

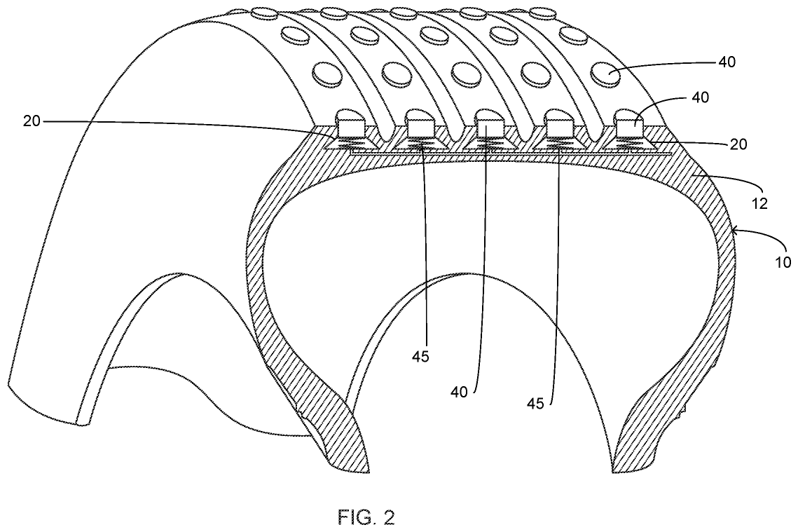

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle tire with gripping members 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring now to the Figures submitted as a part hereof, the vehicle tire with gripping members 100 includes a tread assembly 10. The tread assembly 10 includes a base member 12 and radial support members 14 disposed within the base member 12. The base member 12 is manufactured from rubber and the radial support members 14 are integrally manufactured therewith wherein the radial support members 14 provide the structural integrity for the base member 12. It is contemplated within the scope of the present invention that the base member 12 could be manufactured from alternate types of rubber and further be provided in various thicknesses. The tread assembly 10 is mounted to a conventional vehicle wheel (not particularly illustrated herein) using conventional methods wherein the wheel is pressurized with air so as to inflate the tread assembly to a desired air pressure. While not required, it is desired within the preferred embodiment of the present invention that the vehicle in which the vehicle tire with gripping members 100 are mounted that the vehicle is equipped with a central tire inflation system. This enhances the ease of deployment of the gripping members 40 as will be further discussed herein.

Formed within the base member 12 are a plurality of chambers 20. The chambers 20 have an interior volume 21 and further include bottom end 22 and a top end 23. The interior volume 21 is of suitable size so as to accommodate a gripping member 40 therein when the gripping member 40 is in its first position. The chamber 20 is tapered in shape which assists both in the sealably securing of the gripping member 40 as well as directing of the air pressure such that the air pressure within the interior volume 21 is forced against the bottom 41 of the gripping member 40 only. The gripping member 40 is mounted on a spring 45 wherein the spring 45 is a pressure sensitive spring that is operable to move the gripping member ensuing presence of an air pressure that is greater than the air pressure for which the spring 45 is calibrated. The spring 45 in combination with the air pressure in the interior volume 21 facilitates the movement of the gripping member 40 in an outwards-inwards direction. The interior volume 21 is pneumatically coupled to the air pressure of the vehicle tire with gripping members 100 utilizing tubing 60. Tubing 60 is integrally formed within the tread assembly 10 and functions to provide the necessary air pressure to the chamber 20.

The gripping member 40 has a first position and a second position. In its first position the upper surface 43 of the gripping member 40 is even with that of the upper surface 9 of the base member 12. This position is utilized by users of the vehicle tire with gripping members 100 when normal driving conditions are present and additional traction is not required. In the second position of the gripping member 40, the gripping member 40 has been moved in an outwards direction wherein the upper surface 43 is above that of the upper surface 9 of the base member 12. In this position the gripping members 40 are operable to provide additional traction on surfaces that are covered with snow or ice. While no particular distance of extension is required for the gripping member 40, it is desired within the preferred embodiment of the present invention that the gripping member 40 extend outward from the base member 12 such that the upper surface 43 is approximately one-quarter inch above the upper surface 9 of the base member.

The gripping member 40 is cylindrical in shape and is manufactured from a durable material such as but not limited to metal. While the gripping member 40 is cylindrical in shape in the drawings submitted herewith, it is contemplated within the scope of the present invention that the gripping member 40 could be formed in alternate shapes. By way of example but not limitation, the gripping member 40 could have a tapered upper end. The gripping member 40 is hermetically sealed to the chamber 20 utilizing suitable techniques and elements such as but not limited to O-rings. It should be understood within the scope of the present invention that numerous techniques exist to sealably secure the gripping member 40 within the chamber 20. The spring 45 returns the gripping member 40 to its first position ensuing presence of an air pressure that is lower than that of the force rating of the spring 45. Subsequent the desired use of the gripping members 40, a user will lower the air pressure within the vehicle tire with gripping members 100 and as such the lower air pressure will allow the spring 45 to retract the gripping member 40 to its first position. Alternatively, to move the gripping member 40 to its second position, a user will increase the air pressure within the vehicle tire with gripping members 100 to a sufficient air pressure that will result in the outward movement of the gripping member 40.

It should be understood within the scope of the present invention that various quantities and layout configurations of the gripping member 40 are contemplated within the scope of the present invention. While the drawing submitted herewith illustrates the gripping members 40 in linear rows, it should be understood that is exemplary only and the gripping members 40 could be placed in alternate locations. Additionally, while the preferred embodiment utilizes air pressure to operate the gripping members 40 it is contemplated within the scope of the present invention that the gripping members could be operated mechanically or electrically.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A vehicle tire that is operable to provide improved traction on snow or ice surfaces wherein the vehicle tire comprises:
a tread assembly, said tread assembly having a base member, said base member being mount to a vehicle wheel, said base member being manufactured from a rubber based compound, said base member having an outer surface suitable for traversing roadways; and
a plurality of gripping members, said plurality of gripping members being movably mounted within said base member, said plurality of gripping members movable between a first position and a second position, said plurality of gripping members operable to extend beyond the outer surface of said base member in said second position.

2. The vehicle tire as recited in claim 1, and further including a plurality of chambers, said plurality of chambers being formed in said base member, said plurality of chambers having an interior volume, said plurality of chambers having the plurality of gripping members disposed within the interior volume thereof.

3. The vehicle tire as recited in claim 2, and further including a spring, said spring being disposed within said interior volume of said plurality of chambers, said spring being operably coupled to said plurality of gripping members.

4. The vehicle tire as recited in claim 3, wherein said plurality of chambers are pneumatically coupled to an air source via a tubing network.

5. The vehicle tire as recited in claim 4, wherein said plurality of gripping members are configured to extend beyond the outer surface of the base member by approximately one quarter of an inch.

6. The vehicle tire as recited in claim 5, wherein the plurality of gripping members are cylindrical in shape and hermetically sealed within the plurality of chambers.

7. A vehicle tire that is operable to assist a vehicle traverse across hazardous conditions such as snow or ice wherein the vehicle tire comprises:
a tread assembly, said tread assembly having a base member, said base member being mount to a vehicle wheel, said base member being manufactured from a rubber based compound, said base member having an outer surface suitable for traversing roadways;
a multitude of chambers, said multitude of chambers being formed in said base member, said multitude of chambers having an interior volume, said multitude of chambers having an upper end and a lower end, said multitude of chambers being hermetically sealed,
a multitude of gripping members, said multitude of gripping members being movably mounted within said multitude of chambers, said multitude of gripping members having a top end and a bottom end, said multitude of gripping members movable between a first position and a second position, wherein in said first position said multitude of gripping members are disposed within the interior volume of said multitude of chamber, said multitude of gripping members being sealably secured within said multitude of chambers.

8. The vehicle tire that is operable to assist a vehicle traverse across hazardous conditions such as snow or ice as recited in claim 7, and further including springs, said springs being operably coupled to said multitude of gripping members, said springs configured to retract said multitude of gripping members from said second position into said first position.

9. The vehicle tire that is operable to assist a vehicle traverse across hazardous conditions such as snow or ice as recited in claim 8, wherein in said second position said top end of said multitude of gripping members are extended outward above said outer surface of said base member.

10. The vehicle tire that is operable to assist a vehicle traverse across hazardous conditions such as snow or ice as recited in claim 9, wherein said multitude of chambers are tapered in shape wherein said upper end is more narrow than said lower end.

11. The vehicle tire that is operable to assist a vehicle traverse across hazardous conditions such as snow or ice as recited in claim 10, wherein said multitude of gripping members are manufactured from metal and are cylindrical in shape.

12. The vehicle tire that is operable to assist a vehicle traverse across hazardous conditions such as snow or ice as recited in claim 11, and further including a tubing network, said tubing network configured to pneumatically couple said multitude of chambers to an air source.

13. The vehicle tire that is operable to assist a vehicle traverse across hazardous conditions such as snow or ice as recited in claim 12, wherein in said second position said top end of said multitude of gripping members are extended beyond said outer surface of said base member by approximately one quarter inch.
